(19) United States
(12) Patent Application Publication
(10) Pub. No.: US 2011/0041576 A1
(43) Pub. Date: Feb. 24, 2011

(54) LOCK CORE ASSEMBLY

(76) Inventors: Hsiu-Chuan WU, Kaohsiung (TW); I-Chien HSIN, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/545,951

(22) Filed: Aug. 24, 2009

(51) Int. Cl. E05B 9/04; E05B 63/00

(52) U.S. Cl. 70/371; 70/422

(57) ABSTRACT

A lock core assembly has a lock shell, a lock core and a pin segment. The lock shell has multiple upper pin chambers and a lid. The lock core is mounted rotatably in the lock shell and has multiple lower pin chambers. The lower pin chambers are formed radially through an outer surface of the lock core and respectively align and communicate with the upper pin chambers. The pin segment is mounted between the lock shell and the lock core and has multiple pin assemblies including at least one suspended pin assembly. Each suspended pin assembly has a suspending spring and a suspending block. The suspending spring is connected to a lower pin. The suspending block is mounted on and supported by the suspending spring and abuts with a returning spring.

### BACKGROUND OF THE INVENTION

1. Field of the Invention

The present invention relates to a lock core assembly, and more particularly to a lock core assembly that can provide an excellent burglarproofing effect.

2. Description of Related Art

A conventional lock core assembly for providing a burglarproofing effect substantially has a lock shell, a lock core and multiple pin assemblies. The lock core is mounted rotatably in the lock shell and has a keyhole and an interface defined between the lock core and lock shell. The pin assemblies are respectively mounted in the lock shell and in the lock core and each has a lower pin, an upper pin and a spring. The lower pins are mounted slidably in the lock core and have various lengths. The upper pins are mounted slidably in the lock shell and abut respectively the lower pins. The springs are mounted between the upper pins and the lock shell to push the upper pins against the lower pins.

When the upper pins are disposed at the interface between the lock core and lock shell, the lock core assembly is locked. When a corresponding key is inserted into the keyhole, ridges on the key can push the lower pins to make the bottoms of the upper pins and tops of the lower pins aligning with the interface. Accordingly, the lock core is allowed to rotate relative to the lock shell and the lock core assembly is unlocked.

However, a burglar may use a lock pick to vibrate or knock the lock core assembly to form a gap between the upper and lower pins of the pin assemblies to unlock the lock core assembly arbitrarily. Therefore, the conventional lock core assembly requires an improved burglarproofing.

To overcome the shortcomings, the present invention provides a lock core assembly to mitigate or obviate the aforementioned problems.

### SUMMARY OF THE INVENTION

The primary objective of the present invention is to provide a lock core assembly that can provide an excellent burglarproofing effect.

The lock core assembly in accordance with the present invention has a lock shell, a lock core and a pin segment. The lock shell has a core mount, multiple upper pin chambers, and a lid. The lock core is mounted rotatably in the core mount and has a keyhole and multiple lower pin chambers. The lower pin chambers are formed radially through an outer surface of the lock core, communicate with the keyhole and respectively align and communicate with the upper pin chambers. The pin segment is mounted between the lock shell and the lock core and has multiple pin assemblies. Each pin assembly has a lower pin, an upper pin and a pushing spring. The pin assemblies comprises at least one suspended pin assembly and the upper pin of each one of the at least one suspended pin assembly comprises a suspending spring and a suspending block. The suspending spring is connected to the lower pin. The suspending block is mounted on and supported by the suspending spring and abuts with the returning spring. When knocked, the suspending spring of the at least one suspended pin assembly is compressed to prevent the pin aligning and the lock core from rotating, the lock core assembly provides a preferred burglarproofing effect.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a lock core assembly in accordance with the present invention;

FIG. 2 is a side view in partial section of the lock core assembly in FIG. 1;

FIG. 3 is an operational side view in partial section of the lock core assembly in FIG. 1, shown with a corresponding key inserted into a lock core of the lock core assembly;

FIG. 4 is an operational side view in partial section of the lock core assembly in FIG. 1, shown with a lock pick inserted into a lock core of the lock core assembly; and

FIG. 5 is a side view in partial section of an alternative embodiment of a lock core assembly in accordance with the present invention.

### DETAILED DESCRIPTION OF THE PREFERRED EMBODIMENT

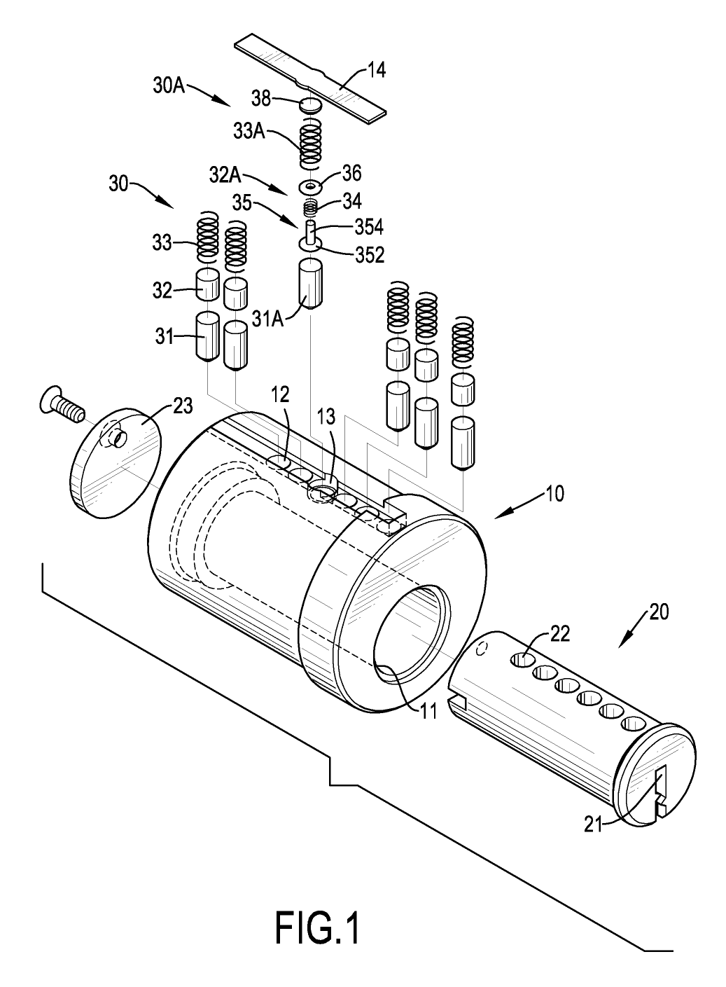

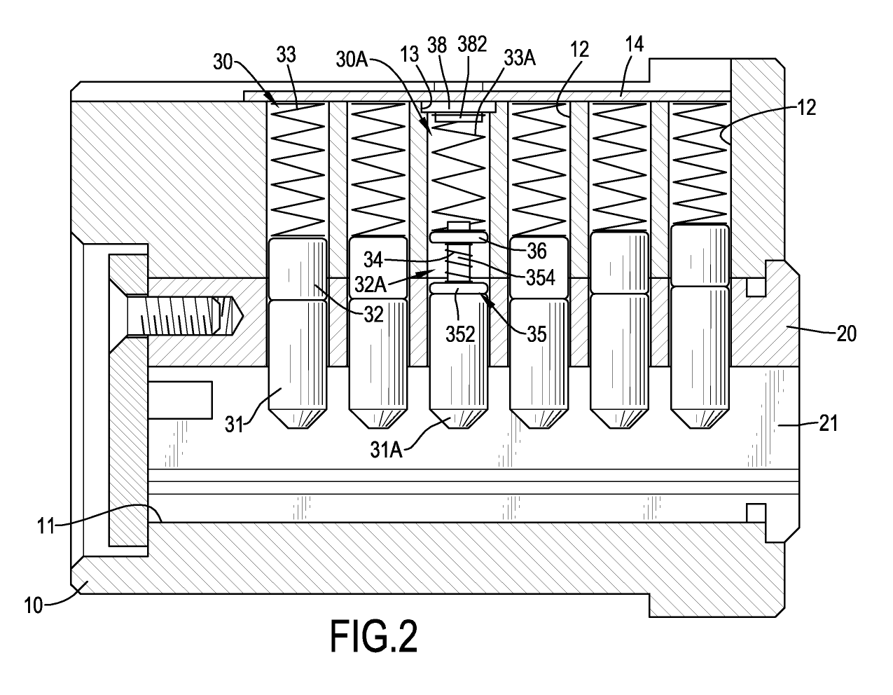

With reference to FIGS. 1 and 2, a lock core assembly in accordance with the present invention has a lock shell (10), a lock core (20) and a pin segment.

The lock shell (10) has an outer surface, a core mount (11), multiple upper pin chambers (12), at least one retaining cavity (13) and a lid (14). The core mount (11) is formed longitudinally through the lock shell (10) and has an inner surface. The upper pin chambers (12) are formed radially in the outer surface of the lock shell (10) and communicate with the core mount (11). The at least on retaining cavity (13) is formed in the outer surface of the lock shell (10), communicates with at least one of the upper pin chambers (12) and has a diameter larger than the at least one upper pin chamber (12). The lid (14) is mounted detachably on the outer surface of the lock shell (10) and covers the upper pin chambers (12) and has an inner face.

The lock core (20) is mounted rotatably in the core mount (11) of the lock shell (10) and has an outer surface, an interface, an outer end, an inner end, a keyhole (21), multiple lower pin chambers (22) and a cap (23). The interface is defined between the outer surface of the lock core (20) and inner surface of the core mount (11). The keyhole (21) is formed longitudinally in the outer end of the lock core (20). The lower pin chambers (22) are formed radially in the outer surface of the lock core (20), communicate with the keyhole (21), and respectively align and communicate with the upper pin chambers (12). The cap (23) is mounted in the core mount (11) of the lock shell (10) and is connected to the inner end of the lock core (20) with a fastener.

The pin segment is mounted between the lock shell (10) and the lock core (20) and has a default position and multiple pin assemblies (30,30A). Each pin assembly (30,30A) is mounted in a corresponding upper pin chamber (12) and a corresponding lower pin chamber (22) and has a lower pin (31,31A), an upper pin (32,32A) and a pushing spring (33,33A). The lower pin (31,31A) is mounted slidably in the corresponding lower pin chamber (22) and has a top end, wherein the lower pins (31, 31A) do not have uniform lengths. The upper pin (32,32A) is mounted slidably between the corresponding upper pin chamber (12) and the lower pin chamber (22), abuts the lower pin (31,31A) and has a top end and a bottom end. The bottom end of the upper pin (32,32A) abuts the top end of the lower pin (31,31A). With the different lengths of the lower pins (31, 31A), in the default situation, the upper pins (32, 32A) of the pin assemblies (30, 30A) are disposed at the interface between the lock shell (10) and the lock core (20) and prevent the lock core (20) from rotating relative to the lock shell (10).

The pushing spring (33,33A) is mounted in the corresponding upper pin chamber (12) between the upper pin (32,32A) and the lid (14), abuts the top end of the upper pin (32,32A) and has a connecting end and a pushing end. The connecting end of the pushing spring (33,33A) is connected to or abuts the lid (14). The pushing end of the pushing spring (33,33A) abuts the top end of the upper pin (32,32A).

The pin assemblies (30,30A) has at least one suspended pin assembly (30A) that is mounted respectively in the at least one upper pin chamber (12) communicating with the at least one retaining cavity (13). Each suspended pin assembly (30A) comprises a suspending spring (34) and a suspending block (36) and may comprise a pushing element (35). The suspending spring (34) is connected to the top end of the lower pin (31A), wherein the pushing spring (33A) has a larger elastic force than that of the suspending spring (34). The suspending block (36) is mounted on and supported by the suspending spring (34) and abuts with the returning spring (33A).

The pushing element (35) is attached to the top end of the lower pin (31A) of the suspended pin assembly (30A), is connected to the suspending spring (34) and comprises a pushing disc (352) and a pushing rod (354). The pushing disc (352) is attached to the top end of the corresponding lower pin (31A) and has a top. The pushing rod (354) is formed on and protrudes from the top of the pushing disc (352) and extends slidably through the suspending block (36). The suspending spring (34) of the suspended pin assembly is mounted around the pushing rod (354) and has two ends abutting respectively with the suspending disc (36) and the pushing disc (352).

In addition, the pin segment further has at least one mounting disc (38) mounted respectively in the at least one retaining cavity (13). Each mounting disc (38) may be mounted securely on the inner face of the lid (14) and has an inner side and a mounting protrusion (382). The mounting protrusion (382) is formed on and protrudes from the inner side of the mounting disc (38), and the connecting end of the pushing spring (33A) of the corresponding suspended pin assembly (30A) connected to and mounted around the mounting protrusion (382).

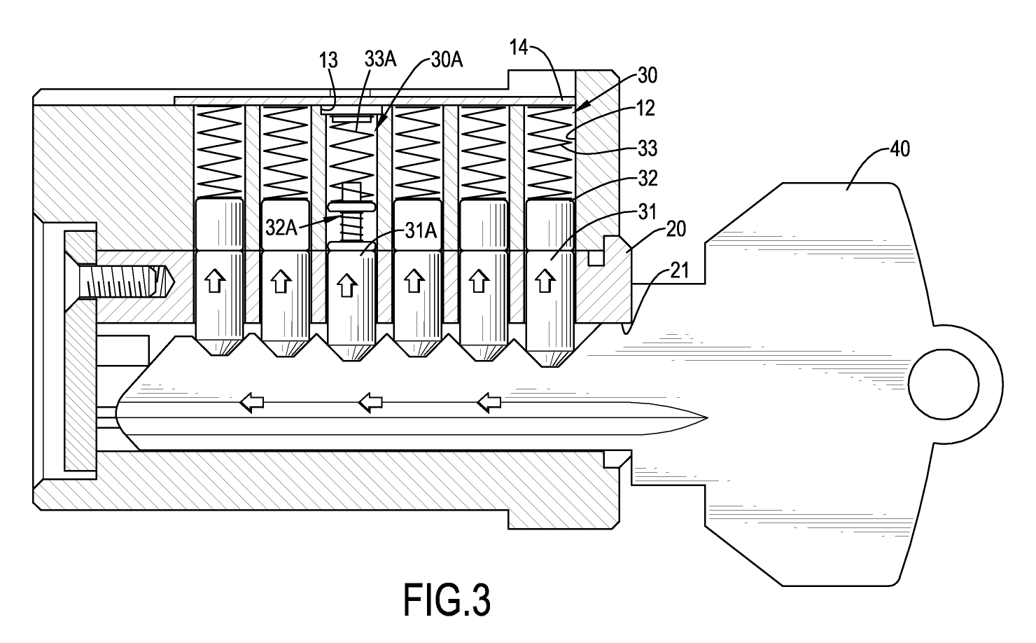

With further reference to FIG. 3, when a corresponding key (40) having multiple ridges is inserted into the keyhole (21) of the lock core (20), the ridges on the key (40) abut and press the pin assemblies (30, 30A) up to align the bottoms of the upper pins (32, 32A) and the tops of the lower pins (31, 31A) with the interface between the core mount (11) and the lock core (20). Accordingly, the lock core (20) is allowed to turn relative to the lock shell (10) to unlock the lock core assembly.

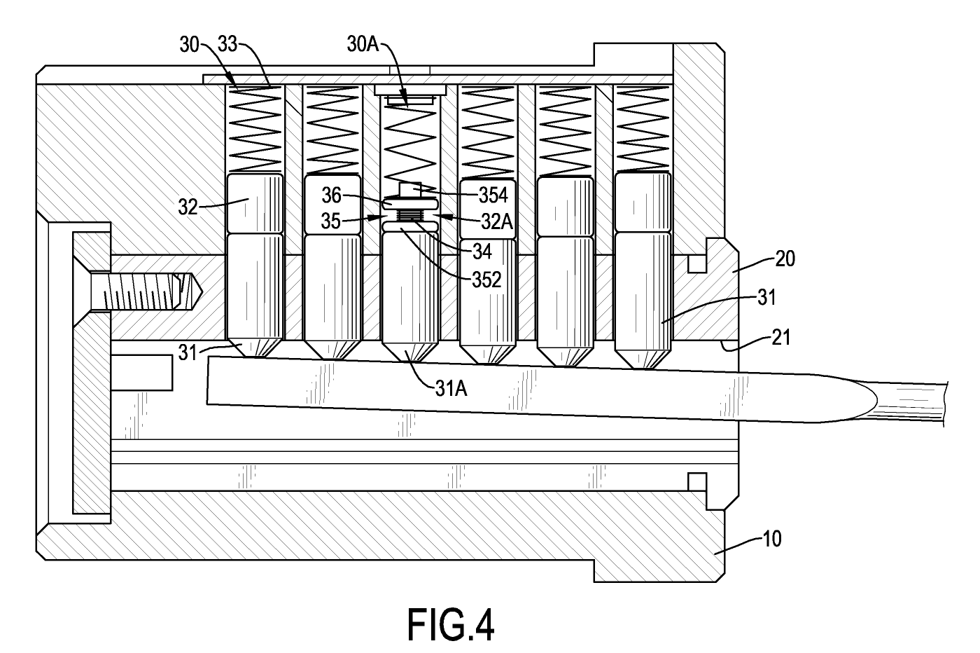

However, with reference to FIG. 4, when a lock pick is used to bounce and align the upper and lower pins (32, 32A, 31, 31A), the suspending spring (34) of the at least one suspended pin assembly will be pushed by the lower pin (31A) and compressed. With the compression of the suspending spring (34), the upper pin (32A) and the lower pin (31A) of the at least one suspended pin assembly (30A) is very difficult to align with the interface, especially simultaneously with the upper pins (32) of the other pin assemblies (30). Therefore, the lock core assembly in accordance with the present invention can provide an excellent burglarproofing effect. Especially, the lock core assembly has multiple suspended pin assemblies, the difficulty of unlocking the lock core assembly with a lock pick is increased.

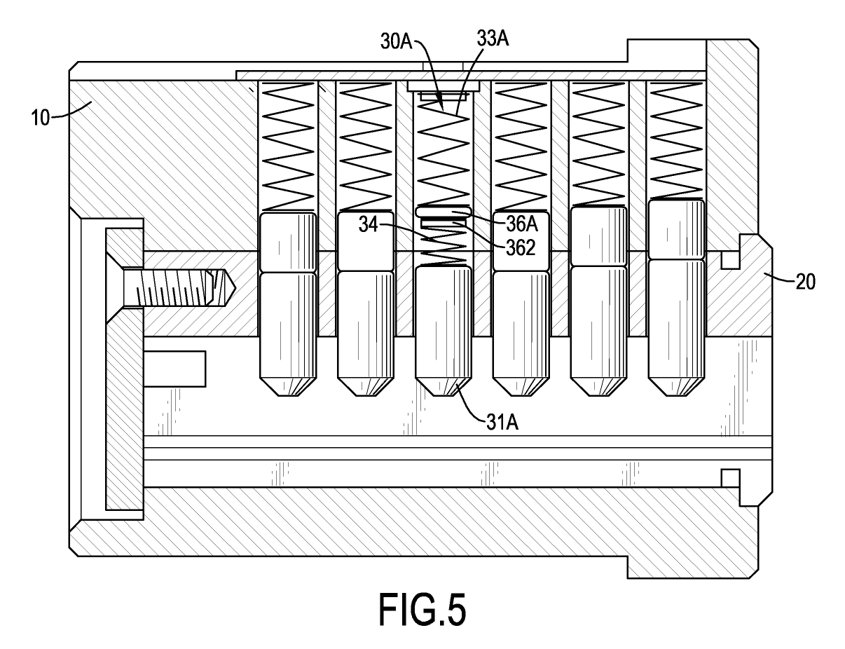

In an alternative embodiment as shown in FIG. 5, the pushing element can be omitted and the suspending spring (34) is attached directly to the top end of the corresponding lower pin (31A). The suspending block (36A) has a stub (362) formed on and protrudes from the bottom of the suspending block (36A), and the suspending spring (34) is mounted around the stub (362). In such an arrangement, the structure of the lock core assembly can be simplified.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lock core assembly having
a lock shell having
an outer surface;
a core mount formed longitudinally through the lock shell and having an inner surface;
multiple upper pin chambers formed radially in the outer surface of the lock shell and communicating with the core mount; and
a lid mounted detachably on the outer surface of the lock shell, covering the upper pin chambers and having an inner face;
a lock core mounted rotatably in the core mount of the lock shell and having
an outer surface; and
an interface defined between the outer surface of the lock core and the inner surface of the core mount;
an outer end;
an inner end mounted in the core mount of the lock shell;
a keyhole being formed longitudinally in the outer end of the lock core; and
multiple lower pin chambers formed radially in the outer surface of the lock core, communicating with the keyhole, and respectively aligning and communicating with the upper pin chambers; and
a pin segment mounted between the lock shell and the lock core and having multiple pin assemblies respectively mounted in the upper and lower pin chambers and each pin assembly having
a lower pin being mounted slidably in one of the lower pin chambers and having a top end;
an upper pin being mounted slidably in a corresponding upper pin chamber and having
a top end; and
a bottom end abutting the top end of the lower pin; and
a returning spring mounted in a corresponding upper pin chamber between the upper pin and the lid and pressing the upper pin against the lower pin, wherein
the pin assemblies comprises at least one suspended pin assembly and the upper pin of each one of the at least one suspended pin assembly comprises
a suspending spring connected to the lower pin; and
a suspending block mounted on and supported by the suspending spring and abutting with the returning spring.

2. The lock core assembly as claimed in claim 1, wherein each one of the at least one suspended pin assembly further comprises a pushing element attached to the top end of the lower pin of the suspended pin assembly, connected to the suspending spring of the suspended pin assembly and comprising
a pushing disc attached to the top end of the corresponding lower pin and having a top;
a pushing rod formed on and protruding from the top of the pushing disc and extending slidably through the suspending block of the suspended pin assembly, wherein the suspending spring of the suspended pin assembly is mounted around the pushing rod.

3. The lock core assembly as claimed in claim 2, wherein the pin segment further has at least one mounting disc and each one of the least one mounting disc has
an inner side; and
a mounting protrusion formed on and protruding from the inner side of the mounting disc, wherein the connecting end of the pushing spring of each one of the at least one suspended pin assembly connected to and mounted around the mounting protrusion of a corresponding mounting disc.

4. The lock core assembly as claimed in claim 3, wherein the pushing spring of each one of the at least on suspended pin assembly has a larger elastic force than that of the suspending spring of the suspended pin assembly.

5. The lock core assembly as claimed in claim 4, wherein the lock core has a cap mounted in the core mount of the lock shell and connected to the inner end of the lock core.

6. The lock core assembly as claimed in claim 5, wherein the lock shell further has at least one retaining cavity defined in the outer surface of the lock shell and communicating respectively with at least one of the upper pin chamber in which the at least one suspended pin assembly is mounted; and
the at least one mounting disc is mounted respectively in the at least one retaining cavity.

7. The lock core assembly as claimed in claim 6, wherein each one of the retaining cavity has a diameter larger than that of a corresponding upper pin chamber.

8. The lock core assembly as claimed in claim 7, wherein the suspending spring of each one of the at least one suspended pin assembly is attached directly to the top end of the lower pin of the suspended pin assembly; and
the suspending block of each one of the at least one suspended pin assembly has a stub formed on and protruding from the bottom of the suspending block and around which a corresponding suspending spring is mounted.

9. The lock core assembly as claimed in claim 1, wherein the pin segment further has at least one mounting disc and each one of the least one mounting disc has
an inner side; and
a mounting protrusion formed on and protruding from the inner side of the mounting disc, wherein the connecting end of the pushing spring of each one of the at least one suspended pin assembly connected to and mounted around the mounting protrusion of a corresponding mounting disc.

10. The lock core assembly as claimed in claim 9, wherein the lock shell further has at least one retaining cavity defined in the outer surface of the lock shell and communicating respectively with at least one of the upper pin chamber in which the at least one suspended pin assembly is mounted; and
the at least one mounting disc is mounted respectively in the at least one retaining cavity.

11. The lock core assembly as claimed in claim 10, wherein each one of the retaining cavity has a diameter larger than that of a corresponding upper pin chamber.

12. The lock core assembly as claimed in claim 1, wherein the pushing spring of each one of the at least on suspended pin assembly has a larger elastic force than that of the suspending spring of the suspended pin assembly.

13. The lock core assembly as claimed in claim 1, wherein the lock core has a cap mounted in the core mount of the lock shell and connected to the inner end of the lock core.

14. The lock core assembly as claimed in claim 1, wherein the suspending spring of each one of the at least one suspended pin assembly is attached directly to the top end of the lower pin of the suspended pin assembly; and
the suspending block of each one of the at least one suspended pin assembly has a stub formed on and protruding from the bottom of the suspending block and around which a corresponding suspending spring is mounted.
